(19) United States
(12) Patent Application Publication
(10) Pub. No.: US 2025/0340405 A1
(43) Pub. Date: Nov. 6, 2025

(54) BUILDING PANEL LIFTING SYSTEM AND METHOD OF USING THE SAME

(71) Applicant: Forge Holdco LLC, Norcross, GA (US)

(72) Inventor: Jeremiah Lowell, Norcross, GA (US)

(21) Appl. No.: 19/198,388

(22) Filed: May 5, 2025

Related U.S. Application Data
(60) Provisional application No. 63/642,936, filed on May 6, 2024.

(51) Int. Cl. B66C 1/34; B66C 1/66

(52) U.S. Cl. CPC B66C 1/34; B66C 1/66

(57) ABSTRACT

A lifting apparatus for a building panel may include a hook portion configured to engage with pre-formed holes in a building panel frame. A body portion may connect to the hook portion. A collar assembly may mount on the body portion. The collar assembly may comprise a collar ring configured to prevent complete passage of the lifting apparatus through an access hole in the building panel. A keeper pin may limit movement of the collar ring relative to the body portion. A swivel connector may attach to the body portion opposite the hook portion. The swivel connector may couple with a lifting device. The hook portion may include a J-shaped distal end sized to fit within the pre-formed holes. The body portion may define multiple keeper pin apertures spaced along its length. The swivel connector may enable rotation in multiple planes.

RELATED APPLICATION(S)

Under provisions of 35 U.S.C. § 119 (e), the Applicant claims the benefit of U.S. Provisional Application No. 63/642,936, filed May 6, 2024, which is incorporated herein by reference.

It is intended that the referenced application may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to construction equipment. Specifically, the present disclosure relates to systems and methods for lifting and installing building panels.

### BACKGROUND

In some situations, construction projects involve the assembly of large, prefabricated panels. For example, these panels may be part of a building's exterior or interior structure.

The conventional strategy is to lift and position these panels using various apparatuses. This often causes problems because the conventional strategy does not provide a method for quickly and securely attaching and removing a reusable lifting apparatus to the panels. For example, traditional methods may require fastening temporary lifting points onto the panels. This approach may be time-consuming and may compromise the structural integrity of the panels. Additionally, the removal of these temporary points post-installation may leave undesirable marks or weaken the panel's surface. Accordingly, the fastened lifting points are left within the panels following installation. The lifting points represent significant monetary cost, and require time to properly fasten to the panels.

In another aspect, the reusability of lifting apparatus is often limited. In fact, conventional lifting points are not re-used. Instead, they remain within the panel after installation, leading to increased costs due to the need for new lifting points for each panel or project. Therefore, there exists a scenario where the handling, lifting, and installation of building panels may benefit from an improved approach that addresses these issues.

Traditionally, each panel includes a plurality of brackets that are welded to support s within the panel. Each bracket includes a threaded aperture for attaching the panel to the crane via a corresponding threaded attachment mechanism, similar to a bolt. Once lifted into position, the plural threaded attachment mechanisms may be removed from the threaded apertures in the brackets, freeing the crane from the panel. However, the bracket, being permanently fastened to the panel, remains in place within the building. Thus, each panel includes excess material used, adding, weight, complexity, and cost to the structure.

Accordingly, there is a need for an easily reusable system for lifting building panels into place without the need to attach any excess material to the panel.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Consistent with embodiment of the present invention, a system may include a plurality of building elements or panels to be lifted, each panel having one or more apertures (lifting holes) disposed in predefined locations of the panel. The system may further include one or more hooks configured to be removably attached to the panel. The one or more hooks may be temporarily installed onto a panel by, for example, a ground based lift crew; this is a quick and easy task whereby the lift crew may temporarily lock the hooks into the lifting holes that are cut into the frame. For example, the lifting holes may be pre-cut during manufacturing or otherwise cut at any time prior to the installation process. A collar and lock pin located on each hook may keep the hook locked into position. The panel is lifted by connecting the installed hooks to a crane or other lifting device, and using the crane or other lifting device to position the panel. A building-based crew may then install the panel into position on the building. Once the panel is safely installed, the hooks may be removed from panel by removing the lock pins and siding each hook out of the lifting holes. The engagement and disengagement of each hook can be relatively fast when compared to traditional lifting points, which require a threaded engagement to hold the building element or panel. Moreover, the hook can easily be reused to lift the plurality of panels without requiring any additional hardware within the panels.

Consistent with embodiments of the present disclosure, a panel lifting system may be described. The system may include a building panel. The building panel may comprise a frame. The frame may have one or more support studs. At least one of the one or more support studs may define a pre-formed hole. The building panel may also have a peripheral edge. The peripheral edge may define one or more access holes. Each access hole may provide access to a corresponding one of the one or more support studs. The system may further include a lifting apparatus. The lifting apparatus may include a hook portion. The hook portion may be disposed at a distal end of the lifting apparatus. The hook portion may be configured to pass through a selected one of the one or more access holes. The hook portion may be accommodated within the pre-formed hole in the corresponding support stud. The lifting apparatus may also include a collar portion. The collar portion may have a collar ring. The collar ring may be configured to prevent the lifting apparatus from passing entirely through the selected one of the access holes. The collar portion may also have a keeper pin. The keeper pin may be configured to limit movement of the collar ring relative to the lifting apparatus. Additionally, the lifting apparatus may include a swivel joint. The swivel joint may be configured to connect the lifting apparatus to a crane or other device used to lift the building panel. The building panel may be installed using the lifting apparatus. No additional hardware may be installed within the building panel to perform the installation process.

In some embodiments, a method of installing a building panel is described. The method may comprise providing a building panel. The building panel may have a plurality of support beams embedded therein. At least one of the support beams may include one or more precut holes. The method may also comprise providing one or more lifting apparatuses. The number of lifting apparatuses may be less than or equal to the number of precut holes in the building panel. The method may further comprise engaging the one or more lifting apparatuses with a subset of the one or more pre-cut holes in the building panel. The one or more lifting apparatuses may be temporarily secured to the building panel. The building panel may be lifted to an installation position using a crane or other lifting device. The one or more lifting apparatuses may be removed from the building panel. The building panel may comprise no hardware used for lifting the building panel.

Consistent with embodiments of the present disclosure, a panel lifting system may include a lifting apparatus that resembles a hook. This lifting apparatus may be configured to engage with a metal frame of a building panel. Additionally, the building panel may comprise a metal frame. This metal frame may have pre-cut holes designed to receive the lifting apparatus.

A method for lifting a building panel using a lifting apparatus may involve providing a building panel. This building panel may have a metal frame with pre-cut holes. A lifting apparatus resembling a hook may be provided. The lifting apparatus may engage with the pre-cut holes in the metal frame of the building panel. The lifting apparatus may be secured to the building panel using a collar and lock pin mechanism. Finally, the building panel may be lifted to an installation position using a crane or other lifting device.

A lifting apparatus for use with a building panel may comprise a hook portion. This hook portion may be configured to engage with pre-cut holes in a metal frame of the building panel. A collar mechanism may be designed to secure the hook portion within the pre-cut holes. Additionally, a lock pin may be operatively connected to the collar mechanism. This lock pin may lock the hook portion in an engaged position.

A building panel, in accordance with embodiments of the present disclosure, may comprise a metal frame. This metal frame may have a plurality of pre-cut holes. Each hole may have a geometry configured to mate with a corresponding lifting apparatus. The pre-cut holes may include a tapered entry. This entry may guide the lifting apparatus into a secure engagement position. Furthermore, the secure engagement position may include a locking feature. This feature may interact with the lifting apparatus to prevent disengagement during lifting.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. All rights to any trademarks and copyrights represented herein, except those belonging to their respective owners, are vested in and the property of the Applicant. The Applicant retains and reserves all rights in any of its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 is a perspective view of a lifting apparatus consistent with the present disclosure;

FIG. 2 is an exploded perspective view of the lifting apparatus of FIG. 1;

FIG. 3 is a perspective view of a building panel lifting system including two lifting apparatuses and a building panel, consistent with the present disclosure;

FIG. 4 is a side view of another embodiment of the building panel lifting system; and

FIG. 5 is a flow chart of a method for using a building panel lifting system.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The building panel lifting system described herein may provide a solution to technical problems associated with conventional panel lifting and installation methods. The technical problems may include the high cost of disposable welded lifting points, time-consuming installation processes, and material waste.

One technical problem with conventional methods may involve welding lifting points directly onto building panel frames. Each welded lifting point may cost approximately $27, and a company may use tens of thousands of these disposable lifting points annually, resulting in significant material and labor costs. The welded lifting points may remain permanently attached to the building panel after installation, creating material waste.

Another technical problem may relate to the time-consuming nature of manually welding lifting points onto each panel. Construction crews may need to weld multiple lifting points per panel, which may slow down the installation process and increase labor costs. The welding process may also create safety hazards on construction sites.

The building panel lifting system described herein may address these technical problems through a reusable lifting apparatus that may engage with pre-formed holes in the building panel frame. The lifting apparatus may include a hook portion that may pass through access holes in the panel edge to engage with corresponding pre-formed holes in the support studs. A collar portion with a keeper pin may secure the lifting apparatus in place during lifting operations.

The pre-formed holes may be manufactured into the panel frame during production, which may eliminate the need for on-site welding. The lifting apparatus may be quickly engaged and disengaged from the pre-formed holes, which may reduce installation time. After panel installation, the lifting apparatus may be removed and reused on subsequent panels, which may eliminate waste from disposable welded lifting points.

Multiple examples of the lifting system's advantages may be demonstrated across various scenarios. In a first example, a construction company installing exterior panels on a multi-story building may use the lifting apparatus to install hundreds of panels without purchasing any disposable welded lifting points. The reusable nature of the lifting apparatus may result in significant cost savings over the course of the project.

In another example, a panel installation crew may complete panel lifts more efficiently since no welding may be required. The crew may simply align the lifting apparatus with the pre-formed holes, engage the keeper pin, and proceed with the lift. This streamlined process may reduce installation time compared to conventional welding methods.

The building panel lifting system may provide technical solutions through its novel combination of pre-formed holes in the panel frame and a reusable lifting apparatus. This system may address the technical problems of high material costs, installation inefficiency, and waste associated with conventional welded lifting points.

The building panel lifting system described herein may provide several technical advantages over conventional panel lifting and installation methods. The reusable lifting apparatus may eliminate material waste by avoiding disposable welded lifting points that remain permanently attached to building panels. Each welded lifting point may cost approximately $27, and with tens of thousands used annually, the reusable system may provide substantial cost savings.

The pre-formed holes manufactured into the panel frame during production may eliminate the need for time-consuming on-site welding operations. The lifting apparatus may be quickly engaged and disengaged from the pre-formed holes, which may reduce installation time compared to manually welding multiple lifting points per panel. This streamlined process may improve overall construction efficiency.

The system may enhance worker safety by eliminating welding operations at construction sites. The secure engagement between the lifting apparatus and pre-formed holes may provide reliable load bearing capacity without requiring permanent modifications to the panel frame. The keeper pin and collar mechanism may prevent unintended disengagement during lifting operations.

The lifting apparatus may accommodate panels of various sizes and configurations through strategic placement of pre-formed holes in the support studs. The swivel joint connection to lifting equipment may allow controlled rotation of panels during positioning. Multiple lifting apparatuses may be used simultaneously to distribute loads evenly across larger panels.

The system may facilitate modular construction methods by enabling quick attachment and removal of lifting equipment. The pre-formed holes may be precisely positioned during manufacturing to optimize load distribution and panel balance during lifting operations. The lifting apparatus may be stackable for efficient storage and transportation between job sites.

The building panel lifting system may reduce environmental impact by eliminating waste from disposable welded lifting points. The reusable nature of the lifting apparatus may decrease material consumption over multiple construction projects. The elimination of on-site welding may reduce energy usage and emissions associated with welding operations.

The system may improve quality control by incorporating engineered lifting points during panel manufacturing rather than relying on field-welded connections. The pre-formed holes may be precisely sized and positioned to ensure consistent engagement with the lifting apparatus. This standardization may enhance reliability and repeatability of lifting operations.

The present disclosure includes many aspects and features. Moreover, while many aspects and features relate to, and are described in, the context of lifting a building panel for a skyscraper or other structure, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The building panel lifting system described herein may provide a novel solution for installing large building panels on structures like skyscrapers and other buildings. The system may include a specialized hook-shaped lifting apparatus that may engage with pre-formed holes manufactured into the metal frame of building panels. This configuration may allow construction crews to quickly attach and detach the lifting apparatus without leaving any permanent hardware on the panels.

The lifting apparatus may resemble an oversized fish hook with additional safety features. A collar ring near the top of the hook may prevent the apparatus from passing completely through the panel. A keeper pin may lock the collar in place during lifting operations. The apparatus may also include a swivel joint that may connect to cranes or other lifting equipment.

The building panels may contain strategically placed holes cut into their metal frames during manufacturing. These holes may be positioned to properly balance the panel when lifted. The lifting apparatus may pass through access holes in the panel edge to engage with corresponding holes in internal support studs. This arrangement may create a secure temporary connection for lifting operations.

After positioning a panel, construction crews may simply remove the lifting apparatus by releasing the keeper pin and sliding the hook out of the pre-formed holes. The apparatus may then be reused on subsequent panels. This may eliminate the need to weld disposable lifting points onto each panel, which may reduce material costs and installation time while preventing waste.

The system may provide enhanced safety features through its secure locking mechanisms. The pre-formed holes and lifting apparatus may be precisely engineered to work together. Multiple lifting apparatuses may be used simultaneously on larger panels to distribute weight evenly. The swivel joint may allow controlled rotation of panels during positioning.

Consistent with embodiments of the present disclosure, a panel lifting system may include a lifting apparatus and a building panel equipped with a metal frame. The lifting apparatus may resemble an oversized hook, specifically designed for engagement with pre-cut holes in the metal frame of the building panel. This unique configuration allows for a secure connection between the lifting apparatus and the building panel, facilitating the lifting and positioning of the panel during construction. The metal frame of the building panel may comprise holes that formed in the studs forming the frame during the manufacturing process or at any time prior to installation. These holes are strategically placed and shaped to receive the lifting apparatus, ensuring a balanced lift of the building panel. The design may include a collar and a lock pin mechanism on the lifting apparatus for securing it within the pre-cut holes, enhancing the stability of the connection during lifting operations.

The lifting apparatus may offer several intuitive design elements that provide technical advantages over traditional methods. For example, the lifting apparatus may be quickly and easily installed onto the building panel by locking into the pre-cut holes, a feature that significantly reduces the time and labor required for panel manufacturing and/or installation. Additionally, the lifting apparatus may be removable and reusable, allowing for multiple lifting operations without the need for welding or otherwise fastening lifting points to the building panel. This reusability presents a cost-effective alternative to traditional lifting points, eliminating the need for welding and thereby reducing the potential for damage to the panel during the lifting process. The lifting apparatus may also include a swivel joint, enabling the rotation of the building panel to the desired orientation when suspended, further illustrating the system's adaptability and efficiency in facilitating construction processes.

Embodiments of the present disclosure may comprise methods, systems, and a computer readable medium comprising, but not limited to, at least one of the following:
A. A Lifting Apparatus;
B. A Prefabricated Building Element;

In some embodiments, the present disclosure may provide an additional set of modules for further facilitating the software and hardware platform. The additional set of modules may comprise, but not be limited to:
C. A Branching Support; and
D. A Swivel Connector.

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single element, it should be understood that, in some embodiments, different operations may be performed by different elements in operative communication with one another.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
providing a building panel having a plurality of support beams embedded therein, at least one of the support beams including one or more connection points;
providing one or more lifting apparatuses, the number of lifting apparatuses being less than or equal to the number of connection points in the building panel;
engaging the one or more lifting apparatuses with a subset of the one or more connection points in the building panel;
temporarily securing the one or more lifting apparatus to the building panel;
lifting the building panel may to an installation position using a crane or other lifting device; and
removing the one or more lifting apparatuses from the building panel, such that the building panel comprises no hardware used for lifting the building panel.

The building panel lifting system may provide numerous technical advantages over conventional panel lifting methods. The reusable nature of the lifting apparatuses may eliminate the need for disposable welded lifting points, which may reduce material costs and waste. Each welded lifting point may cost approximately $27, and a construction company may use thousands of these points annually, resulting in substantial cost savings when using the reusable lifting system.

The pre-formed holes in the panel frame may eliminate the need for on-site welding operations, which may reduce installation time and labor costs. The lifting apparatuses may be quickly engaged and disengaged from the pre-formed holes, which may streamline the panel installation process. This efficiency may be particularly beneficial for large construction projects involving numerous panels.

The lifting system may enhance worker safety by eliminating welding operations at construction sites. The secure engagement between the lifting apparatuses and pre-formed holes may provide reliable load-bearing capacity without requiring permanent modifications to the panel frame. The keeper pin and collar mechanism may prevent unintended disengagement during lifting operations.

The system may accommodate panels of various sizes and configurations through strategic placement of pre-formed holes in the support studs. The swivel joint connection to lifting equipment may allow controlled rotation of panels during positioning. Multiple lifting apparatuses may be used simultaneously to distribute loads evenly across larger panels.

The system may facilitate modular construction methods by enabling quick attachment and removal of lifting equipment. The pre-formed holes may be precisely positioned during manufacturing to optimize load distribution and panel balance during lifting operations. The lifting apparatuses may be stackable for efficient storage and transportation between job sites.

The building panel lifting system may reduce environmental impact by eliminating waste from disposable welded lifting points. The reusable nature of the lifting apparatuses may decrease material consumption over multiple construction projects. The elimination of on-site welding may reduce energy usage and emissions associated with welding operations.

The system may improve quality control by incorporating engineered lifting points during panel manufacturing rather than relying on field-welded connections. The pre-formed holes may be precisely sized and positioned to ensure consistent engagement with the lifting apparatus. This standardization may enhance reliability and repeatability of lifting operations.

The present disclosure provides a building panel lifting system that may offer significant advantages over conventional panel lifting methods. The reusable lifting apparatus may eliminate the need for disposable welded lifting points, which may reduce material costs and waste. The pre-formed holes in the panel frame may streamline the installation process and may enhance the efficiency of panel lifting operations.

The system may include various safety features, such as the collar ring and keeper pin mechanism, which may prevent unintended disengagement during lifting. The swivel connector may facilitate precise positioning of panels during installation. Multiple lifting apparatuses may be used simultaneously to distribute loads evenly across larger panels.

The building panel lifting system may be adaptable to various panel sizes, configurations, and materials. The lifting apparatus may be manufactured from durable materials to ensure longevity through multiple lifting operations. The system may integrate with existing lifting equipment, such as cranes and hoists, without requiring specialized modifications.

Overall, the building panel lifting system may provide a cost-effective, efficient, and environmentally friendly solution for panel installation in construction projects. The reusable nature of the lifting apparatus may generate substantial cost savings over traditional welded lifting points, while the streamlined engagement process may reduce installation time and labor costs.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the

### DETAILED DESCRIPTION

### II. Platform Configuration

The lifting system may be implemented within construction environments where large building panels require secure lifting and precise positioning during installation. The system may operate in various construction settings including high-rise buildings, commercial structures, and industrial facilities where exterior panel installation occurs.

The system may function within an infrastructure that includes tower cranes, mobile cranes, or other heavy lifting equipment commonly found at construction sites. The lifting apparatus may interface with standard crane rigging through the swivel joint connection. This connection point may enable 360-degree rotation of suspended panels during positioning operations.

The manufacturing environment for the building panels may incorporate automated or semi-automated processes for creating the pre-formed holes in the metal frame components. The holes may be precision-cut during frame fabrication using computer numerical control (CNC) machinery or similar manufacturing equipment. This controlled manufacturing process may help ensure consistent hole placement and dimensional accuracy.

The installation environment may involve multiple trades working simultaneously, requiring the lifting system to operate efficiently within congested work zones. The system may function in various weather conditions including wind, rain, and temperature extremes typical of construction sites. The reusable nature of the lifting apparatus may allow it to withstand repeated exposure to these environmental factors.

Storage facilities may be required to house the lifting apparatuses between uses. The apparatus design may enable efficient stacking and organization within standard construction storage containers or tool cribs. The portable nature of the system may allow for easy transport between different work zones or construction sites.

Quality control environments may be established to regularly inspect the lifting apparatuses and verify the integrity of pre-formed holes in panel frames. Testing equipment may be used to confirm load-bearing capabilities remain within specified tolerances. Documentation systems may track usage history and maintenance records for individual lifting apparatuses.

Safety monitoring infrastructure may include inspection protocols for verifying proper engagement between lifting apparatuses and panels before each lift. Visual indicators and mechanical lockouts may provide verification of secure connections. Emergency protocols may be established for safely handling equipment malfunctions or environmental hazards during lifting operations.

Embodiments of the system may include one or more lifting apparatuses that enable efficient and secure engagement with prefabricated building elements, such as panels. The system may incorporate a lifting apparatus with a hook portion specifically designed to mate with holes cut in a frame of a building panel or element, helping to ensure a precise and stable connection. A collar mechanism may be included to securely hold the hook portion within the pre-cut holes, while a lock pin may be operatively connected to the collar mechanism to maintain the hook portion in an engaged position. This configuration may allow for quick installation and removal without the need for welds, screws, bolts, etc., offering a reusable solution that may be advantageous for construction projects.

The lifting apparatus may include a main body portion extending from a proximal end to a distal end. The main body portion may comprise a substantially cylindrical shaft. A hook portion may be disposed at the distal end of the main body portion. The hook portion may be configured to pass through an access hole in a peripheral edge of a building panel to engage with a pre-formed hole in a support stud of the building panel frame.

A collar assembly may be disposed on the main body portion between the proximal and distal ends. The collar assembly may include a collar ring configured to prevent the lifting apparatus from passing entirely through the access hole when the hook portion engages the pre-formed hole. The collar ring may be adjustable along the length of the main body portion to accommodate different panel thicknesses.

A keeper pin may be operatively connected to the collar assembly. The keeper pin may be configured to secure the collar ring at a selected position along the main body portion during lifting operations. The keeper pin may include a spring-loaded mechanism that automatically engages when the collar ring reaches the selected position.

The proximal end of the main body portion may include a swivel joint. The swivel joint may be configured to connect the lifting apparatus to a crane or other lifting device. The swivel joint may enable 360-degree rotation of the building panel when suspended.

The hook portion may have a curved profile specifically designed to mate with the geometry of the pre-formed holes in the support studs. The curved profile may include a tapered leading edge to facilitate insertion into the pre-formed holes. The hook portion may also include wear-resistant surfaces at points of contact with the pre-formed holes.

The main body portion may define one or more cavities configured to reduce the overall weight of the lifting apparatus while maintaining structural integrity. The cavities may be strategically positioned to optimize the strength-to-weight ratio of the apparatus.

A handle portion may extend from the main body portion near the proximal end. The handle portion may be ergonomically shaped to facilitate manual manipulation of the lifting apparatus during engagement and disengagement operations. The handle portion may include textured grip surfaces.

Visual indicators may be provided on the main body portion and/or collar assembly. The visual indicators may confirm proper engagement of the keeper pin and secure positioning of the collar ring. The indicators may include high-visibility markings or mechanical flags that deploy when components are properly engaged.

The lifting apparatus may be manufactured from high-strength materials capable of withstanding repeated use without deformation. The materials may include heat-treated alloy steels or other metals with suitable strength and durability characteristics. Surface treatments may be applied to enhance wear resistance and prevent corrosion.

Multiple lifting apparatuses may be used simultaneously on a single building panel. The number and positioning of lifting apparatuses may be determined based on panel size, weight distribution, and installation requirements. The lifting apparatuses may be configured to work in coordinated groups to ensure balanced lifting operations.

In alternative embodiments, the lifting apparatus may include various modifications and enhancements to the basic hook design. The hook portion may include a wear-resistant coating or surface treatment to extend its operational lifespan through repeated use. The coating may comprise a hardened metal alloy, ceramic composite, or polymer material selected for high abrasion resistance.

The collar assembly may incorporate an auto-locking mechanism that may engage automatically when the collar ring reaches the proper position along the main body portion. The auto-locking feature may include a spring-loaded detent that may snap into a corresponding recess. Visual and tactile indicators may confirm proper engagement of the auto-locking mechanism.

The keeper pin may be configured with multiple securing positions to accommodate different panel thicknesses. The keeper pin may include graduated markings to indicate the engagement depth. A secondary locking mechanism may provide redundant security by preventing unintended release of the primary keeper pin.

The swivel joint may incorporate sealed bearings to ensure smooth rotation under load. The bearings may be selected for resistance to environmental contaminants commonly encountered at construction sites. The swivel joint may include stops to limit rotation to a predetermined range if desired for specific applications.

The main body portion may be manufactured from various high-strength materials including tool steel, titanium alloys, or composite materials. The materials may be selected based on strength-to-weight requirements for different load capacities. Surface treatments may enhance corrosion resistance for outdoor use.

The handle portion may be ergonomically shaped with textured grip surfaces to facilitate manual manipulation in adverse weather conditions. The handle may incorporate shock-absorbing materials to reduce operator fatigue. High-visibility markings may be applied to enhance visibility in low-light conditions.

Multiple lifting apparatuses may be used in coordinated groups for handling large panels. The lifting apparatuses may include built-in load sensors to monitor weight distribution between multiple pickup points. Wireless communication between lifting apparatuses may enable synchronized operation. The load sensors may be integrated into the lifting apparatus in several configurations. The load sensors may be positioned within the main body portion between the hook portion and the swivel joint. The sensors may include strain gauges mounted on flat surfaces machined into the main body portion.

Multiple load sensor mounting points may be provided along the length of the main body portion. The mounting points may comprise recessed pockets sized to accommodate standardized load cell modules. The load cells may be secured within the mounting pockets using removable fasteners.

The load sensor may include visual indicators mounted on the main body portion. The indicators may provide real-time feedback on load conditions during lifting operations. Warning lights may activate if loads exceed predetermined thresholds.

Multiple lifting apparatuses used on a single panel may communicate load data between units. The distributed sensor network may enable monitoring of load balance across all pickup points. Wireless modules in each apparatus may share data in real-time.

The pre-formed holes in the panel frame may include reinforced edges to prevent wear from repeated use. The hole geometry may incorporate lead-in chamfers to guide the hook portion during engagement. Visual alignment markers may assist proper positioning of the lifting apparatus.

The access holes in the panel edge may be sized to provide adequate clearance while preventing misalignment during engagement. The access holes may include protective grommets or bushings to prevent damage to panel materials. Weather sealing features may be incorporated around the access holes.

Alternative embodiments of the building panel may include different frame configurations while maintaining compatibility with the lifting apparatus. The frame may incorporate additional structural reinforcement around lifting points for enhanced load capacity. The panel may include provisions for temporary weather protection during installation.

The lifting system may be adapted for automated or semi-automated operation in certain applications. Robotic manipulators may engage and position the lifting apparatus. Computer control systems may coordinate multiple lifting points for precise panel positioning.

Safety features may include mechanical lockouts to prevent operation unless all components are properly engaged. Emergency release mechanisms may allow controlled disconnection under load if required. Impact-absorbing features may protect components from accidental contact damage.

The system may incorporate provisions for regular inspection and maintenance of critical components. Wear indicators may signal when replacement of components may be needed. Documentation systems may track usage history and maintenance records for quality control purposes.

Storage and transportation features may include protective covers for the lifting apparatus when not in use. Stacking provisions may allow efficient storage of multiple units. The lifting apparatus may be designed for easy disassembly to facilitate maintenance access.

The building panel may include integrated connection points for securing adjacent panels. The connection points may be designed for compatibility with standard building fasteners. Weather sealing features may be incorporated at panel joints.

Accordingly, embodiments of the present disclosure provide a system comprised of a set of components including, but not limited to:

### A. A Lifting Apparatus

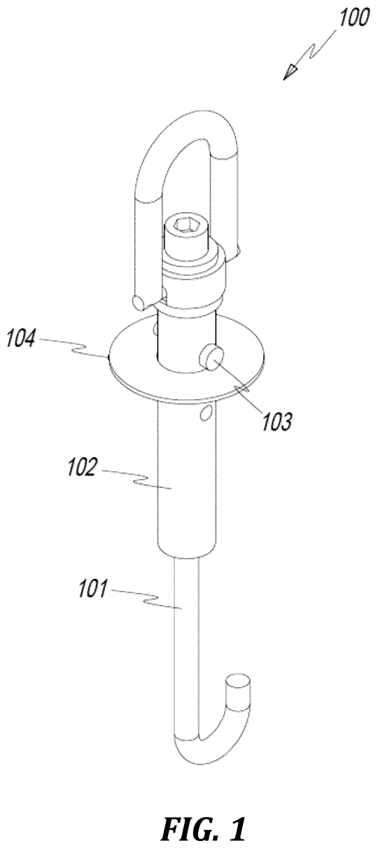

As best shown in FIGS. 1-4, embodiments of the system 10 may include one or more lifting apparatuses 100 that enable efficient and secure engagement with building panels. Each lifting apparatus may include a hook potion 101, a body portion 102, a keeper pin 103, a collar 104, and a rotatable attachment mechanism 105.

With reference to FIG. 1, a lifting apparatus 100 for building panels may be provided. The lifting apparatus 100 may include a hook portion 101, a body portion 102, a keeper pin 103, and a collar ring 104. The hook portion 101 may be configured to engage with pre-formed holes in a building panel frame. The body portion 102 may be connected to the hook portion 101 and may extend substantially linearly from the hook portion 101. The collar ring 104 may be mounted on the body portion 102 and may be configured to prevent complete passage of the lifting apparatus 100 through an access hole in the building panel. The keeper pin 103 may be configured to limit movement of the collar ring 104 relative to the body portion 102.

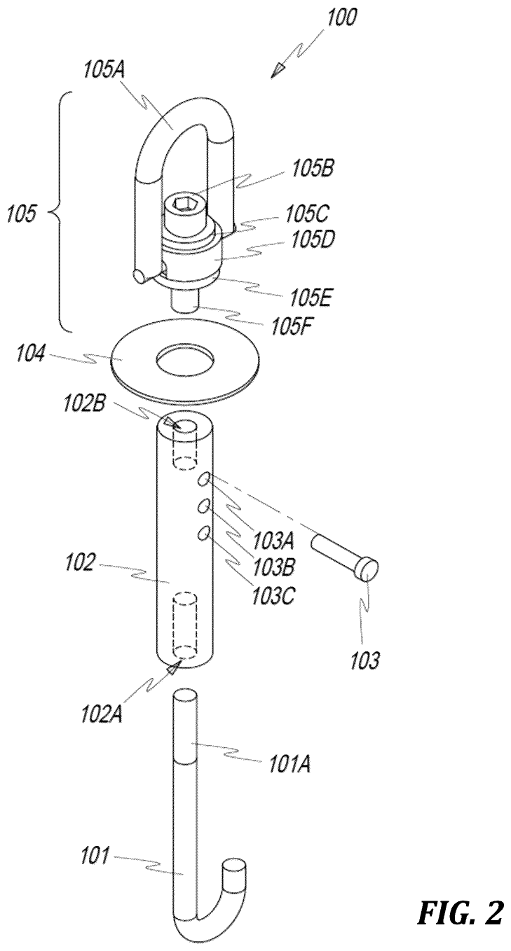

As shown in FIG. 2, the lifting apparatus 100 may include a swivel connector 105 attached to the body portion 102 opposite the hook portion 101. The swivel connector 105 may be configured to couple with a lifting device such as a crane or other hoisting equipment. The swivel connector 105 may include a ring member 105A, a collar member 105B rotatably coupled to the ring member 105A, and a threaded rod 105F extending from the collar member 105B and engaging with the body portion 102. This configuration may allow multi-axial rotation of the lifting apparatus 100 relative to the lifting device.

The hook portion 101 may comprise a generally J-shaped distal end 101A sized to fit within pre-formed holes of the building panel frame. The J-shaped distal end 101A may include a beveled edge at its terminus to facilitate insertion into the pre-formed holes. This beveled edge may guide the hook portion 101 into alignment with the pre-formed holes during engagement operations.

The body portion 102 may define a plurality of keeper pin apertures 103A, 103B, 103C spaced along its length to allow adjustable positioning of the keeper pin 103. These apertures may be uniformly spaced to provide multiple positions for securing the collar ring 104 at different locations along the body portion 102. This adjustability may accommodate building panels of varying thicknesses or configurations.

The collar ring 104 may have an inner diameter larger than an outer diameter of the body portion 102 and smaller than an outer diameter of the keeper pin 103. This dimensional relationship may allow the collar ring 104 to slide freely along the body portion 102 until secured by the keeper pin 103. The outer diameter of the collar ring 104 may be substantially larger than the access hole in the building panel to prevent the lifting apparatus 100 from passing completely through the panel during lifting operations.

The keeper pin 103 may include a spring-loaded locking mechanism configured to automatically engage with the keeper pin apertures in the body portion 102. This spring-loaded mechanism may provide quick and secure engagement without requiring additional tools or fasteners. The keeper pin 103 may also include a release mechanism to facilitate disengagement when removing the lifting apparatus 100 from the building panel.

Consistent with embodiments of the present disclosure, the hook portion 101 of the lifting apparatus 100 may be shaped to engage with pre-cut holes in a metal frame of a building panel. The hook may be generally J-shaped, and may have a distal end configured for engagement with a building panel and a proximal end configured for engagement with the body portion 102. In some embodiments, the dimensions of the hook portion 101 may closely match that of pre-cut holes in a building panel. This design may allow for a snug fit that minimizes lateral movement during lifting operations. In other embodiments, the hook portion 101 may be relatively thinner, allowing for material and weight savings. The hook portion 101 may include a beveled edge at the distal end of the hook. This edge may facilitate smooth entry into the pre-cut holes. Such an entry minimizes the risk of damaging the building panel or the pre-cut holes themselves. As best shown in FIG. 2, the proximal end of the hook portion 101 may include a threaded portion 101A. The threaded portion 101A may be configured to engage with the body portion 102 of the lifting apparatus 100.

In some embodiments, the hook portion 101 may optionally be coated with a high-friction material. This coating may enhance grip within the pre-cut holes, helping to prevent slippage, and/or to ensure a secure lifting process. In embodiments, the hook portion 101 may be formed from a relatively strong, durable material, such as (but not limited to) steel or iron.

The body portion 102 may be formed to have a diameter that exceeds that of the hook portion 101. In this way, the hook portion 101 may be at least partially surrounded by the body portion 102 when the hook portion is installed in the body portion. For example, as shown in FIG. 2, the body portion 102 may include a first cavity 102A. The first cavity 102A may include a threaded wall configured to may be with at least a part of the threaded portion 101A of the hook 101. In embodiments, the threaded engagement between the hook 101 and the body 102 allows for an adjustable length of the overall lifting apparatus 100. Moreover, the threaded engagement allows for easy rotation of the hook 101 relative to the body 102.

In embodiments, the body portion 102 may further include a second cavity 102B. The second cavity may facilitate engagement between the body portion 102 and the rotatable attachment mechanism 105.

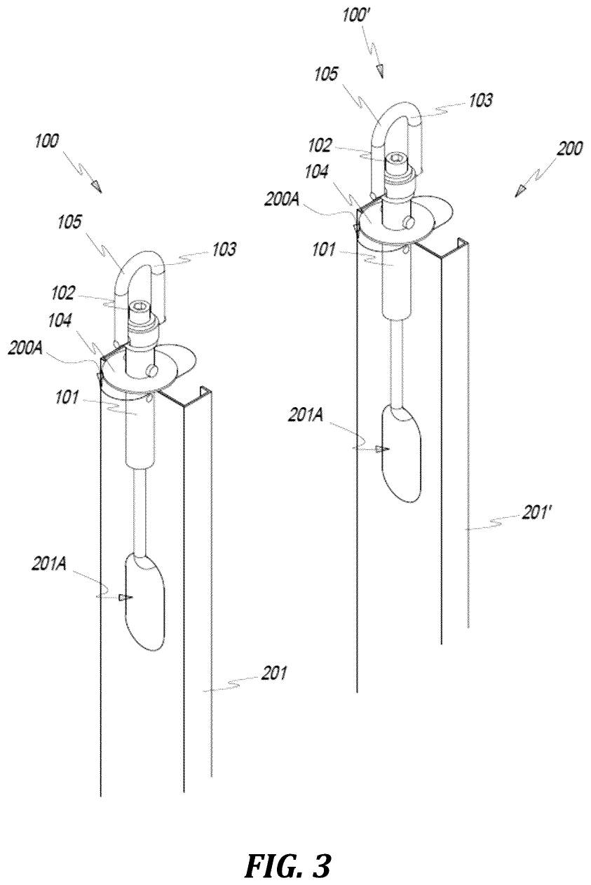

The lifting assembly 100 may include a keeper pin 103 and a collar 104. In embodiments, the keeper pin 103 may be a pin configured to pass through the body portion 102 via a keeper pin aperture defined therein. As shown in FIG. 2, the body 102 defines three keeper pin apertures 103A, 103B, 103C. However, those of skill in the art will recognize that more or fewer keeper pin apertures may be defined without departing from the scope of the invention. The keeper pin 103 may be designed to engage selectively with one of the multiple keeper pin apertures such as 103A, 103B, or 103C. This design allows for adjustable positioning of the keeper pin 103 relative to the body 102. The adjustment capability may accommodate different sizes or types of building panels. The keeper pin 103 may be fabricated from a material that offers high strength and durability. This ensures that the keeper pin 103 can withstand the stresses associated with lifting operations. The end of the keeper pin 103 may be tapered. This taper may facilitate easier insertion into the keeper pin apertures. The keeper pin 103 may also include a handle. This handle may enable manual manipulation of the keeper pin 103 for insertion or removal. The keeper pin 103 may be retained within the body 102 by a friction fit. This may prevent accidental dislodgement during use. The keeper pin 103 may also include a locking mechanism. This locking mechanism may secure the keeper pin 103 in a selected aperture, preventing movement during lifting operations. The design of the keeper pin 103 may allow for quick and easy adjustment. This may enhance the efficiency of the lifting process. The keeper pin 103 may be removable. This may facilitate maintenance or replacement if necessary. The keeper pin 103 may also be designed to minimize wear on the body 102. This may extend the service life of the lifting assembly 100. In some embodiments, the locking mechanism of the keeper pin 103 may include a compression spring housed within a cylindrical cavity of the keeper pin body. The collar 104 may be formed as an adjustable component. In embodiments, the collar 104 may be formed as a relatively flat, annular part, having an inner diameter that is larger than the diameter of the body portion 102, but less than the length of the keeper pin 103. The outer diameter of the collar 104 may be larger than a diameter of an access hole 200A in the building panel 200, as shown in FIG. 3. In this way, the collar 104 may be prevented from passing through the access hole. The collar 104 may be disposed below the keeper pin 103 on the assembled lifting mechanism. In this way, the keeper pin 103 may inhibit upward movement of the collar 104 beyond the location of the keeper pin. This in turn prevents downward movement of the hook 101, preventing accidental disengagement of the hook from a hole in the support column.

The lifting apparatus may further include a rotatable attachment mechanism 105. In embodiments, the rotatable attachment mechanism 105 may engage with the body portion 102. For example, the second cavity 102B of the body portion 102 may include a threaded sidewall, and the rotatable attachment mechanism 105 may include a rod 105F having a threaded portion configured to threadedly engage the body portion.

The rotatable attachment mechanism 105 may include an attachment ring 105A rotatably connected to a collar 105D. As shown in FIGS. 1-4, the attachment ring 105A may be formed as a D-ring, though other shapes are contemplated. The attachment ring 105A may facilitate attachment between the lifting apparatus 100 and a crane or other lifting device (e.g., via a cable or the like). The attachment ring 105A is rotatably attached to the collar 105D, such that the ring is rotatable relative to the collar.

The collar 105D is rotatably fixed to the rod 105F, such that the collar 105D rotates about an axis defined by the rod 105F. the rotation of the collar 105D may be substantially orthogonal to the rotation of the ring 105A. In this way, the attachment mechanism may be rotated in nearly any direction without affecting the orientation of the hook 101. The collar 105D may be held rotatably captive between an upper movement restrictor 105C and a lower movement restrictor 150E. Movement restrictors 105C and 105E substantially inhibit translation movement of the collar 105D while permitting rotation of the collar. A fastener 105B, such as a nut, rivet, or other fastener.

### B. A Prefabricated Building Element

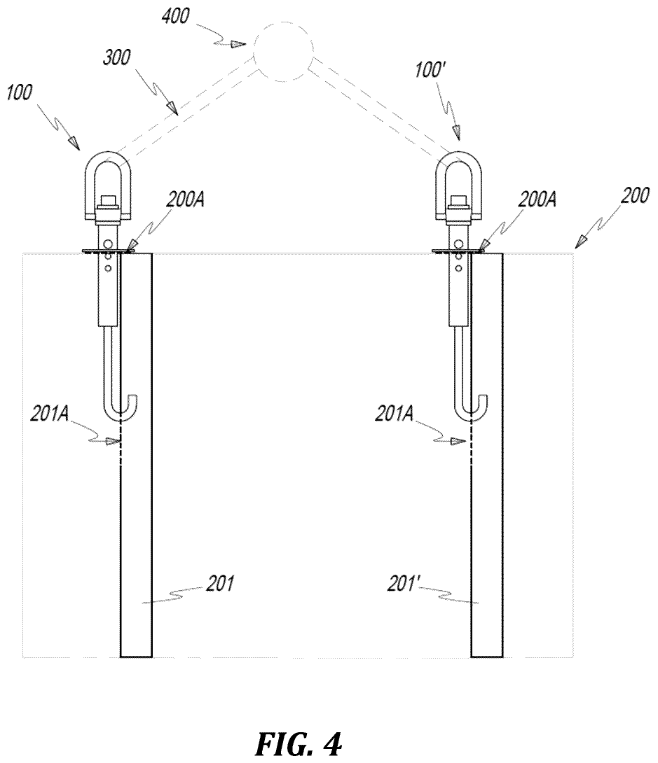

As best shown in FIGS. 3-4, embodiments of the system 10 may include a prefabricated building element 200, such as a building panel. The building element of panel 200 may have one or more support studs 201. The building panel 200 may include access holes 200A formed in the panel 200. Each access hole 200A may provide access to a corresponding one of the one or more support studs. As shown in FIG. 3, the access holes 200A may have oval or elongated shapes, however, other shapes may be used without departing from the invention. The dimensions of each access hole 200A should allow the hook 101 and at least a portion of the body 102 to extend therethrough, but should be smaller than an outer diameter of the collar 104, such that the collar 104 does not pass through the access hole 200A. In this way, the collar 104 and the keeper pin 103 set the maximum depth to which the lifting mechanism 100 can extend into the building panel 200.

With reference to FIG. 3, a building panel 201 for use with the lifting apparatus 100 may be provided. The building panel 201 may include a metal frame having one or more support studs 201A embedded within the panel structure. The support studs 201A may include pre-formed holes manufactured into the studs during the panel fabrication process. These pre-formed holes may be strategically positioned to provide balanced lifting points for the panel.

The building panel 201 may also include access holes formed in the edge of the panel. These access holes may align with the pre-formed holes in the support studs 201A to allow insertion of the hook portion 101 of the lifting apparatus 100. The access holes may be sized to permit passage of the hook portion 101 while preventing passage of the collar ring 104.

The pre-formed holes in the support studs 201A may be shaped to accommodate the J-shaped distal end 101A of the hook portion 101. This configuration may create a secure connection between the lifting apparatus 100 and the building panel 201 during lifting operations. The pre-formed holes may include reinforced edges to distribute lifting forces across a larger area of the support studs 201A.

The building panel 201 may be constructed from various materials, including but not limited to metal, concrete, composite materials, or combinations thereof. The panel construction may incorporate insulation, vapor barriers, and exterior finishing materials as required for the specific building application. The panel dimensions may vary according to the building design requirements.

As discussed above, the building panel 200 may further include one or more support studs 201. The one or more support studs 201 may be constructed from a durable material, such as (but not limited to) metal (e.g., steel, aluminum, etc.). This material may be selected for its strength, durability, and/or resistance to environmental factors. As shown in FIGS. 3-4, the support studs 201 are generally vertically oriented, however, other orientations may be possible.

One or more (e.g., each) of the one or more support studs 201 may define one or more holes 201A. In some embodiments, at least one of the one or more holes 201A may be cut into the support studs during manufacturing or at any time prior to installation of the element of panel 200. Additionally or alternatively, at least one of the one or more holes 201A may be formed in the support stud 201 via a molding process. In embodiments, each hole 201A may be dimensioned to accommodate at least a portion of the hook 101. In particular, the distal end of the hook 101 may be accommodated within the hole 201A. In some embodiments, the geometry of the holes 201A may correspond to the shape of the hook 101. This correspondence may ensure a snug fit, reducing the possibility of lateral movement during lifting operations. In other embodiments, the holes 201A may serve a dual purpose (e.g., to allow wiring pipes, or other materials to pass through the support stud 201.

The hole 201A and the support stud 201 may be configured such that the weight of the panel 200 may be supported in the support studs 201. In some embodiments, a perimeter of each hole 201A may be reinforced. Reinforcement may enhance the structural integrity at the lifting points. A chamfered edge may be incorporated around each hole 201A. The chamfered edge may aid in the smooth insertion of the lifting apparatus. As shown in FIGS. 3 and 4, the panel may include plural support studs 201. While FIGS. 3 and 4 depict a panel having two support studs, additional support studs may be included within the panel without departing from the scope of the invention.

A frame of the building panel 200 may be formed from metal. In some embodiments, the metal frame may be coated with a corrosion-resistant material. This coating may extend the usable life of the building panel 200 by protecting it against rust and corrosion. Alignment features may be included on the building panel 200 (e.g., on the frame). These features may assist in the proper positioning of the building panel 200 relative to adjacent panels during installation. The holes 201A may be strategically placed on the metal frame. Placement may allow for multiple lifting configurations, accommodating various lifting scenarios. Integrated connection points may be included on the frame. These points may facilitate the secure attachment of the building panel 200 to a building structure.

### C. A Branching Support

As best shown in FIG. 4, some embodiments of the system 10 may optionally include a branching support 300 configured to interconnect a plurality of lifting apparatuses 100. The branching support 300 may have a central support position, and may include a plurality of support lines extending outward from the central position to the lifting apparatuses.

### D. A Swivel Connector

As best shown in FIG. 4, some embodiments of the system 10 may optionally include a swivel connector 400. The swivel connector may pivotably connect the branching support 300 to a crane or other lifting apparatus.

With reference to FIG. 4, a complete building panel lifting system may include multiple lifting apparatuses 100, 100′ engaging with a building panel 201. The system may also include a lifting device 400 connected to the lifting apparatuses 100, 100′ via their respective swivel connectors 105. The lifting device 400 may be a crane, hoist, or other suitable equipment capable of lifting and positioning the building panel 201.

For larger panels, multiple lifting apparatuses 200A may be employed simultaneously to distribute the lifting load evenly across the panel structure. The number and positioning of the lifting apparatuses may be determined based on the panel size, weight, and structural characteristics. The lifting apparatuses may be connected to a common lifting point on the lifting device 400 or to separate attachment points as required for balanced lifting.

The swivel connectors 105 of the lifting apparatuses 100, 100′ may enable rotation of the building panel 201 during lifting and positioning operations. This rotational capability may facilitate precise alignment of the panel with its intended installation location. The swivel connectors 105 may allow rotation about multiple axes to accommodate various installation angles and orientations.

### III. PLATFORM OPERATION

Embodiments of the present disclosure provide a platform operative by a set of methods. The following depicts an example of at least one method of a plurality of methods that may be performed by the platform.

For example, although methods may be described as being performed by a single device, it should be understood that, in some embodiments, different operations may be performed by different elements in operative communication.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Building Panel Lifting Method

Consistent with embodiments of the present disclosure, a method may be performed by at least one of the aforementioned modules. The method may be embodied as, for example, but not limited to, computer instructions, which, when executed, perform the method.

Consistent with embodiments of the present disclosure, a method for lifting a building panel involves several stages. Initially, a building panel equipped with a frame that includes one or more pre-formed holes is provided. Following this, one or more lifting apparatuses, each of which resembles a hook, are also provided. The next stage involves engaging each lifting apparatus with a corresponding pre-formed hole located in the frame of the building panel. Once engagement is achieved, the lifting apparatus is secured to the building panel utilizing a collar and lock pin mechanism. The final stage of this method involves lifting the building panel to an installation position with the aid of a crane or another lifting device. This sequence of stages facilitates the lifting and installation of building panels in a manner that is both efficient and secure.

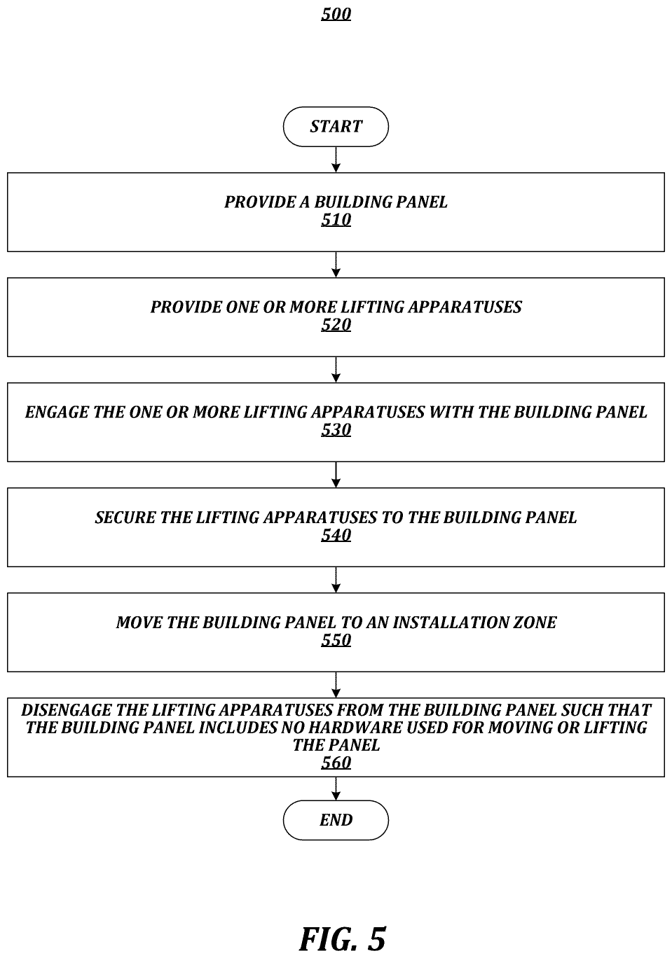

FIG. 5 is a flow chart setting forth the general stages involved in a method 500 consistent with an embodiment of the disclosure using the building panel lifting system 10.

Method 500 may begin at stage 510 where a building panel may be provided. For example, a building panel may be provided at a staging area or preparation area associated with a building site. In embodiments, the provided building panel may include a metal frame having one or more pre-formed holes for use as lift points to lift the panel into position on a building or other structure. The panel may further include access holes in the panel. Each access hole may provide access to at least one corresponding pre-formed hole from outside the panel.

The one or more pre-formed holes may be manufactured into support studs that form the frame of the building panel. The pre-formed holes may be positioned at strategic locations on the frame to allow for multiple lifting configurations. These holes may be sized to accommodate a diameter of a hook portion of a lifting apparatus. The strategic placement of these holes in the metal frame may help to balance the building panel when lifted. In some embodiments, the pre-formed holes may be reinforced around their perimeters to increase the structural integrity of the lifting points. The pre-formed holes may be shaped to correspond to a cross-sectional shape of the lifting apparatus to help prevent rotational and/or lateral movement during lifting. A chamfered edge on each pre-formed hole may aid in the engagement with the lifting apparatus.

In some embodiments, the frame may be coated with a corrosion-resistant material to extend the usable life of the building panel. Alignment features on the building panel may assist in positioning of the building panel relative to adjacent panels during installation. The pre-formed holes may be positioned at strategic locations on the frame to allow for multiple lifting configurations. Integrated connection points for securing the panel to a building structure may be included in the metal frame design.

The method 500 may include stage 520 where one or more lifting apparatuses may be provided. Each lifting apparatus may be generally J-shaped, resembling a hook. A distal end of each lifting apparatus may include a hook portion configured to engage the building panel. A proximal end of each lifting apparatus may be configured to connect to a crane of other lifting device. Each lifting apparatus may be formed from a durable, high-strength material, such as steel. In some embodiments, one or more (e.g., each) lifting apparatus may be coated with a high-friction material. In embodiments, the number of provided lifting apparatuses may be less than or equal to the number of pre-formed holes in the frame of the building panel.

Each lifting apparatus may include a collar and a keeper pin to prevent the lifting apparatus from passing entirely through an access hole and to secure the lifting apparatus in the pre-formed holes of the building panel. The collar of the lifting apparatus may be adjustable along the length of the lifting apparatus (e.g., using various placements of the keeper pin) to accommodate frames of varying thicknesses and/or pre-formed holes at different distances from a peripheral edge of the panel.

The lifting apparatus may include a main body portion extending from a proximal end to a distal end. The main body portion may comprise a substantially cylindrical shaft having one or more cavities formed therein. The cavities may reduce the overall weight of the lifting apparatus while maintaining structural integrity. The cavities may be strategically positioned to optimize the strength-to-weight ratio of the apparatus.

A hook portion may be disposed at the distal end of the main body portion. The hook portion may be configured to pass through an access hole in a peripheral edge of a building panel to engage with a pre-formed hole in a support stud of the building panel frame. The hook portion may have a curved profile specifically designed to mate with the geometry of the pre-formed holes in the support studs. The curved profile may include a tapered leading edge to facilitate insertion into the pre-formed holes. The hook portion may also include wear-resistant surfaces at points of contact with the pre-formed holes.

A collar assembly may be disposed on the main body portion between the proximal and distal ends. The collar assembly may include a collar ring configured to prevent the lifting apparatus from passing entirely through the access hole when the hook portion engages the pre-formed hole. The collar ring may be adjustable along the length of the main body portion to accommodate different panel thicknesses. The collar assembly may incorporate sealed bearings to allow smooth movement along the main body portion.

A keeper pin may be operatively connected to the collar assembly. The keeper pin may be configured to secure the collar ring at a selected position along the main body portion during lifting operations. The keeper pin may include a spring-loaded mechanism that automatically engages when the collar ring reaches the selected position. The keeper pin may have multiple securing positions to accommodate different panel thicknesses. Visual indicators may confirm proper engagement of the keeper pin.

The proximal end of the main body portion may include a swivel joint. The swivel joint may be configured to connect the lifting apparatus to a crane or other lifting device. The swivel joint may enable 360-degree rotation of the building panel when suspended. The swivel joint may incorporate sealed bearings for smooth rotation under load. The bearings may be selected for resistance to environmental contaminants commonly encountered at construction sites.

A handle portion may extend from the main body portion near the proximal end. The handle portion may be ergonomically shaped to facilitate manual manipulation of the lifting apparatus during engagement and disengagement operations. The handle portion may include textured grip surfaces to enhance control in adverse weather conditions. The handle portion may incorporate shock-absorbing materials to reduce operator fatigue during repeated use.

The lifting apparatus may be manufactured from high-strength materials capable of withstanding repeated use without deformation. The materials may include heat-treated alloy steels or other metals with suitable strength and durability characteristics. Surface treatments may be applied to enhance wear resistance and prevent corrosion. The materials may be selected based on strength-to-weight requirements for different load capacities.

Multiple lifting apparatuses may be used simultaneously on a single building panel. The number and positioning of lifting apparatuses may be determined based on panel size, weight distribution, and installation requirements. The lifting apparatuses may be configured to work in coordinated groups to ensure balanced lifting operations. Load sensors may monitor weight distribution between multiple pickup points.In stage 530, each lifting apparatus maybe be engaged with the building panel. For example, each lifting apparatus may pass through an access hole to engage a corresponding one of the pre-formed holes in the frame of the building panel. This may be accomplished by aligning the hook portion of the lifting apparatus with the corresponding pre-formed hole and inserting the distal end of the lifting apparatus into the pre-formed hole. In this way, the lifting apparatus may be quickly engaged with the building element or panel. Moreover, the engagement does not require any fastening (e.g., via a bolt or screw), Rather, the engagement relies on gravitational force to maintain connection between the lifting apparatus and the building element.

In stage 540, the lifting apparatuses may be secured to the building panel. For example, the collar may be positioned adjacent to the peripheral edge of the building panel, and the keeper pin may be adjusted to the lowest position at which the pin can be inserted above the collar to fit the thickness of the frame and/or the placement of the pre-formed hole along the support stud. This helps to ensure a snug and secure fit, and may help to prevent any potential slippage or misalignment during the lifting process, and particularly during placement of the building panel in the installation area.

In embodiments, a user may visually and/or physically confirm the engagement of the lifting apparatus and/or placement of the keeper pin with the lifting apparatus using a visual indicator. This feature may serve as a verification step to ensure that the lifting apparatus is securely attached before lifting begins.

Method 500 may include stage 550, in which the building panel may be moved to an installation zone. For example, the building panel may be connected to a crane or other lifting device via the one or more engaged lifting apparatuses. Thereafter, the building panel may be (approximately) positioned by an operator. In particular, the operator may position the panel using the crane or other lifting device. One or more crewmen at the installation area may guide the panel to an assigned installation position. For example, the crewmen may use indicia, such as letters and/or symbols on the building panel to determine an installation location associated with the building panel. The crewmen and/or the operator may guide the building panel to the assigned installation location. The crewmen may rotate the panel to a correct orientation, and may install the panel via one or more bolts, one or more welds, and/or any other means of installing building panels, as Is known in the art. Stage 550 may introduce the inclusion of a swivel joint in the lifting apparatus, allowing for rotation of the building panel to a desired orientation while it is suspended. This feature enhances the versatility of the lifting apparatus, enabling precise positioning of the panel during installation.

In stage 560, the one or more lifting apparatuses may be separated from the building panel once the panel is installed. For example, the crewmen may release the keeper pins and disengage the lifting apparatuses from the pre-formed holes. Thereafter the crewmen may guide each lifting apparatus out of the panel through the access hole. In this way, the panel may be installed and no additional hardware is installed within the panel. Moreover, no extra hardware is left within the panel and the one or more lifting apparatuses may be re-used to lift additional panels.

Stage 560 includes disengaging the lifting apparatus from the building panel after installation. This may be achieved by releasing the lock pin and sliding the lifting apparatus out of the holes formed in the studs. In this way, the lifting apparatus may be quickly disengaged from the building element or panel. Moreover, the ease of disengagement facilitates the reuse of the lifting apparatus for subsequent lifting operations.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A lifting apparatus for a building panel, comprising:
a hook portion configured to engage with pre-formed holes in a building panel frame;
a body portion connected to the hook portion;
a collar assembly mounted on the body portion, the collar assembly comprising:
a collar ring configured to prevent complete passage of the lifting apparatus through an access hole in the building panel, and
a keeper pin configured to limit movement of the collar ring relative to the body portion; and
a swivel connector attached to the body portion opposite the hook portion, the swivel connector configured to couple with a lifting device.

2. The lifting apparatus of claim 1, wherein the hook portion comprises a J-shaped distal end sized to fit within the pre-formed holes of the building panel frame.

3. The lifting apparatus of claim 1, wherein the body portion defines a plurality of keeper pin apertures spaced along its length to allow adjustable positioning of the keeper pin.

4. The lifting apparatus of claim 1, wherein the swivel connector comprises:
a ring member;
a collar member rotatably coupled to the ring member; and
a threaded rod extending from the collar member and engaging with the body portion.

5. The lifting apparatus of claim 1, wherein the hook portion includes a beveled edge at its distal end to facilitate insertion into the pre-formed holes.

6. The lifting apparatus of claim 1, wherein the collar ring has an inner diameter larger than an outer diameter of the body portion and smaller than an outer diameter of the keeper pin.

7. The lifting apparatus of claim 1, wherein the swivel connector enables rotation of the ring member in a first plane and rotation of the collar member in a second plane substantially orthogonal to the first plane.

8. A lifting apparatus for installing building panels, comprising:
a main body having a proximal end and a distal end;
an engagement hook disposed at the distal end of the main body, the engagement hook configured to pass through an access opening in a building panel and engage with a pre-formed aperture in a support stud of the building panel;
an adjustable stop mechanism mounted on the main body, comprising:
a stop collar slidably disposed on the main body, and
a retention pin insertable through the main body to fix a position of the stop collar; and
a pivot coupling disposed at the proximal end of the main body, the pivot coupling configured to provide multi-axial rotation relative to a lifting device.

9. The lifting apparatus of claim 8, wherein the main body defines a plurality of pin holes spaced longitudinally along its length to provide multiple positions for securing the stop collar via the retention pin.

10. The lifting apparatus of claim 8, wherein the engagement hook comprises:
a curved portion extending from the distal end of the main body; and
a terminal end portion oriented substantially parallel to the main body.

11. The lifting apparatus of claim 8, wherein the pivot coupling comprises:
a first rotational joint providing rotation about a first axis; and
a second rotational joint providing rotation about a second axis perpendicular to the first axis.

12. The lifting apparatus of claim 8, wherein the stop collar comprises an annular member having:
an inner opening sized to slide along the main body; and
an outer diameter larger than the access opening in the building panel.

13. The lifting apparatus of claim 8, wherein the engagement hook includes a tapered leading edge configured to guide the hook into alignment with the pre-formed aperture.

14. The lifting apparatus of claim 8, wherein the retention pin comprises a spring-loaded locking mechanism configured to automatically engage with the pin holes in the main body.

15. A lifting apparatus for building panels, comprising:
a main body having a proximal portion and a distal portion;
a hook member extending from the distal portion, the hook member comprising:
a curved segment configured to pass through an access hole in a building panel, and
a terminal segment oriented substantially parallel to the main body for engaging a pre-formed hole in a support stud of the building panel;
a collar assembly mounted on the main body, comprising:
an annular stop member having an inner diameter sized to slide along the main body and an outer diameter larger than the access hole, and
a locking pin insertable through at least one aperture defined in the main body to fix a position of the annular stop member; and
a swivel connector attached to the proximal portion of the main body.

16. The lifting apparatus of claim 15, wherein the main body defines a plurality of apertures spaced longitudinally along its length to provide multiple positions for securing the annular stop member.

17. The lifting apparatus of claim 15, wherein the swivel connector comprises:
a ring portion configured to couple with a lifting device;
a collar portion rotatably connected to the ring portion; and
a threaded shaft extending from the collar portion and engaging with the proximal portion of the main body.

18. The lifting apparatus of claim 15, wherein the hook member includes a beveled leading edge configured to guide the hook member into alignment with the pre-formed hole.

19. The lifting apparatus of claim 15, wherein the locking pin comprises a spring-loaded mechanism configured to automatically engage with the at least one aperture in the main body.

20. The lifting apparatus of claim 15, wherein the swivel connector enables rotation of the ring portion about a first axis and rotation of the collar portion about a second axis perpendicular to the first axis.
